(19) United States
(12) Patent Application Publication
(10) Pub. No.: US 2024/0284557 A1
(43) Pub. Date: Aug. 22, 2024

(54) RADIO COMMUNICATION

(71) Applicant: Nordic Semiconductor ASA, Trondheim (NO)

(72) Inventors: Vinayak Kariappa CHETTIMADA, Hyderabad (IN); Asbjørn SÆBØ, Trondheim (NO); Emil GYDESEN, Aalborg (DK)

(73) Assignee: Nordic Semiconductor ASA, Trondheim (NO)

(21) Appl. No.: 18/443,009

(22) Filed: Feb. 15, 2024

(30) Foreign Application Priority Data
Feb. 17, 2023 (GB) 2302273.4

(51) Int. Cl. H04W 76/40; H04L 12/18

(52) U.S. Cl. CPC H04W 76/40; H04L 12/1868; H04L 12/1886; H04L 12/189

(57) ABSTRACT

A method of operating a radio communication system is provided comprising a central radio device and a plurality of peripheral radio devices. The method comprises the central radio device receiving data from a first peripheral radio device over a first unicast radio connection; the central radio device broadcasting a radio signal in which data received from the first peripheral radio device are encoded; at least one peripheral radio device receiving the radio signal broadcast by the central radio device and decoding the data encoded therein; the central radio device receiving data from a second peripheral radio device over a second unicast radio connection; the central radio device broadcasting a radio signal in which data received from the second peripheral radio device are encoded; and at least one peripheral radio device receiving the radio signal broadcast by the central radio device and decoding the data encoded therein.

### CROSS REFERENCE TO RELATED APPLICATION

This application claims priority from Great Britain Application No. 2302273.4, filed Feb. 17, 2023, which application is incorporated herein by reference in its entirety.

### BACKGROUND OF THE INVENTION

The present invention relates to radio communication systems and methods of operating radio communication systems.

Many digital radio communication protocols are based on one-to-one connections (also known as unicast connections), in which two radio devices communicate only with each other. For instance, many of the Bluetooth communication protocols support unicast connections between central and peripheral devices.

Some radio communication protocols also facilitate one-to-many communications, in which one device broadcasts radio signals that can be detected by all suitable devices in range. For instance, version 5.2 of the Bluetooth protocol provides broadcast functionality, which can be used to broadcast data (e.g. audio data) from one device to many devices.

However, there is limited support in existing digital radio communication protocols for many-to-many communication, in which a group of several devices can all communicate with each other at the same time. This may be useful, for instance, to facilitate audio communications between groups of people. An improved approach may be desired.

### SUMMARY OF THE INVENTION

According to a first aspect of the present invention there is provided a method of operating a radio communication system comprising a central radio device and a plurality of peripheral radio devices, the method comprising:
the central radio device receiving data from a first peripheral radio device over a first unicast radio connection;
the central radio device broadcasting a radio signal in which data received from the first peripheral radio device are encoded;
at least one peripheral radio device receiving the radio signal broadcast by the central radio device and decoding the data encoded therein;
the central radio device receiving data from a second peripheral radio device over a second unicast radio connection;
the central radio device broadcasting a radio signal in which data received from the second peripheral radio device are encoded; and
at least one peripheral radio device receiving the radio signal broadcast by the central radio device and decoding the data encoded therein.

Thus, it will be appreciated by those skilled in the art that using the central radio device to broadcast data from multiple peripheral radio devices enables robust and efficient many-to-many communication between multiple radio devices of the radio communication system without needing to establish numerous and potentially-complex two-way communications between each device.

Direct one-to-one connections between each pair of radio devices are not needed for peripheral radio devices to receive data from multiple other radio devices (e.g. the first and second peripheral radio devices) or for peripheral radio devices (e.g. the first and second peripheral radio devices) to transmit their data to multiple other radio devices. This may improve the efficiency with which each radio device engages in many-to-many communication (e.g. because devices do not need to maintain multiple connections) whilst also reducing radio capacity requirements for many-to-many communication (e.g. because only one broadcast and a limited number of unicast connections may be active at any one time).

The central radio device effectively acts to relay data from the first and second peripheral radio devices to all other peripheral radio devices in range. The central radio device can thus coordinate the many-to-many communication between the radio devices, improving the quality and robustness of the underlying communication. For instance, as explained in more detail below, the central radio device may arbitrate requests from peripheral radio devices to communicate data to ensure that the data broadcast to the other peripheral radio device(s) is comprehensible and useful). Moreover, using the central radio device as a relay may simplify and improve the reliability of the many-to-many communication, because peripheral radio devices only have to receive a single broadcast to receive data from multiple other devices, i.e. without needing frequent changes to reception settings. This central radio device may, for instance, coordinate a smooth transition between peripheral radio devices receiving audio data from the first peripheral radio device to audio data from the second peripheral radio device.

The central radio device may receive data from the first peripheral radio device in an encoded form (i.e. encoded in a radio signal). The central radio device may broadcast the same encoded data with minimal or no processing (e.g. by simply forwarding encoded data packets into the broadcast). Alternatively, the central radio device may decode the data from the first peripheral radio and then re-encode this data into the broadcast radio signal (e.g. with a different coding scheme).

Because the central radio device broadcasts the radio signal (i.e. as a one-way, one-to-many transmission), it is not reliant on acknowledgment signals from peripheral radio devices receiving the broadcast. The unicast connection involves one-to-one and preferably two-way communication (e.g. with the central radio device acknowledging data from the peripheral radio device(s)), but there may only be a limited number of unicast connections so this approach may be conveniently scalable to systems with larger numbers of radio devices without requiring substantial increases in power or processing resources of any individual device. The radio signal broadcast by the central radio device can in theory be received by any number of peripheral radio devices in range. In a set of embodiments, the radio communication system comprises three or more peripheral radio devices, five or more peripheral radio devices, ten or more peripheral radio devices or even twenty or more peripheral radio devices.

The central radio device may also broadcast its own data to the peripheral radio devices. In a set of embodiments, the method comprises the central radio device broadcasting a radio signal in which data produced by the central radio device are encoded.

The approach disclosed herein is also easily scalable to include communication from additional peripheral radio devices. In a set of embodiments, the method comprises:
the central radio device receiving data from at least one further peripheral radio device over at least one further unicast radio connection;
the central radio device broadcasting a radio signal in which data received from the at least one further peripheral radio device are encoded; and
at least one peripheral radio device receiving the radio signal broadcast by the central radio device and decoding the data encoded therein.

In some embodiments, every peripheral device in the system may be operable to transmit data to the central radio device for broadcast. Such embodiments may support full many-to-many communication, where every radio device in the system can communicate data to and receive data from every other radio device in the system.

The approach disclosed herein may be use any suitable digital radio communication protocol, i.e. in which data are encoded using a digital modulation technique such as phase-shift keying or frequency-shift keying. Preferably a packet-based protocol is used. In a set of embodiments, data received and/or broadcast by the central radio device are encoded using Gaussian frequency-shift keying (GFSK) or differential encoded quaternary phase-shift keying (DQPSK). In a set of embodiments, radio signals forming by the unicast connections and/or the radio signals broadcast by the central radio device are frequency hopping spread-spectrum (FHSS) signals. The radio devices may be Bluetooth devices (e.g. Bluetooth Low Energy (BLE) devices). The radio devices may be arranged to communicate using Bluetooth Isochronous Channels (ISOC). One or more of the radio devices may be radio transceiver devices (i.e. operable to transmit and receive radio signals).

In a set of embodiments, the first and/or second unicast radio connection comprises a Connected Isochronous Stream (CIS). The radio signal(s) broadcast by the central radio device may comprise a Broadcast Isochronous Stream (BIS).

The radio devices may operate according to the Bluetooth LE Audio protocol. The central radio device may act as a BLE unicast client and the peripheral radio device may act as a BLE unicast server, or vice-versa. The central radio device may act as a BLE broadcast source and the peripheral radio device(s) as BLE broadcast sink(s).

Preferably the first and/or second unicast radio connection uses the same radio communication protocol as the radio signals broadcast by the central radio device (e.g. BLE Audio).

In some embodiments, the central radio device receives data from the first and second peripheral radio devices at different times. Data received at different times may be broadcast simultaneously (after both receptions) but, in a set of embodiments, the central radio device may broadcast at a first time a radio signal in which data received from the first peripheral radio device are encoded and subsequently broadcast at a second time a radio signal in which data received from the second peripheral radio device are encoded. The radio signals at the first and second time effectively form part of a single continuous broadcast. This may be applicable, for instance, in an audio communication implementation where a first speaker with the first peripheral radio device speaks at a first time and a second speaker with the second peripheral radio device speaks at a second time, with the speech being transmitted to the central radio device and relayed on to other radio devices via the broadcast in real time.

Receiving and broadcasting data from the first and second peripheral radio devices at different times may provide useful many-to-many communication whilst reducing peak radio capacity use and necessitating lower processing resources at the central radio device. In some embodiments the central radio device may maintain the first and/or second unicast radio connections even when not actively receiving data, e.g. to avoid delays associated with re-establishing the connection later. For instance, the central radio device may maintain the first and/or second unicast radio connections at the same time even whilst only receiving data over these connections at different times.

However, in a set of embodiments, the central radio device maintains the first and second unicast connections at different times. For instance, the central radio device may break the first unicast radio connection and then make the second unicast radio connection after receiving the data from the first peripheral radio device. There may be no time overlap between the first and second unicast radio connections. This may reduce radio capacity use.

Times at which the central radio device broadcasts data from the first and/or second peripheral radio devices (e.g. the first and/or second times) may be based on a predetermined communication schedule. For instance, the radio communication system may agree in advance a communication schedule in which the first and second peripheral radio devices (and possibly further devices) have allocated broadcast timings, and the central radio device switches from receiving and broadcasting data from the first peripheral radio device to receiving and broadcasting data from the second peripheral radio device at the time indicated by the schedule. The schedule may comprise a fixed and equal broadcast duration for each peripheral radio device (i.e. the first, second and any further radio devices). Alternatively, the schedule may comprise a repeating pattern of broadcast durations for data from some or all radio devices and/or entirely bespoke broadcast durations for some or all radio devices (e.g. timed for certain expected events).

The schedule may be based on time. For instance, the schedule may set out one or more timings (e.g. a start time, a duration and/or an end time) for the receiving and broadcasting of data from the first and/or second radio device. However, in some embodiments, additionally or alternatively, the communication schedule may use other parameters to coordinate the devices, such as a quantity of data received and/or broadcast or a number of packets received and/or broadcast. For instance, the schedule may indicate to transition to the second peripheral radio device after a set number of packets from the first peripheral radio device.

Agreeing a communication schedule in advance may be a particularly robust mechanism for performing many-to-many communication, because even if a peripheral radio device fails or moves out of range, communication can simply continue with the next peripheral radio device at its allocated point in the schedule. However, a predetermined communication schedule may not be appropriate for all many-to-many communications. For instance, in some applications it may not be known in advance when or how long a peripheral radio device needs to transmit data for broadcast. For instance, the radio communication system may be used for oral communication between multiple people, in which each person may wish to talk at unpredictable times and for an unpredictable amount of time.

In a set of embodiments, the central radio device may transition from broadcasting data from the first peripheral radio device to broadcasting data from the second peripheral radio device in response to a transition signal. The transition signal may comprise a request or an instruction to switch to broadcasting data from the second peripheral radio device. The transition signal may include an indication of when the transition is to occur.

In a set of embodiments, the central radio device assesses a transition signal and transitions from broadcasting data from the first peripheral radio device to broadcasting data from the second peripheral radio device according to said assessment (i.e. the central radio device may perform (or not perform) the requested transition according to said assessment, e.g. by applying pre-set arbitration rules). In other words, the central radio device may decide to grant or refuse broadcast requests from peripheral radio devices. This may help to ensure that the many-to-many communication is coherent and intelligible.

In a set of embodiments, the transition signal is issued by the first peripheral radio device, e.g. over the first unicast radio connection. For instance, the first peripheral radio device may request (or simply instruct unilaterally) that the second peripheral radio device take over broadcasting. A transition signal issued by the first peripheral radio device may also simply indicate that it has finished transmitting for now and that the second peripheral radio device is free to take over broadcasting if needed. In a set of embodiments, the transition signal is issued by the second peripheral radio device. For instance, the second peripheral radio device may request (or decide unilaterally) to take over broadcasting and issue the transition signal accordingly. For instance, a user of the second radio device may trigger the transition signal by pressing a “push-to-talk” button.

The transition signal may comprise an advertising signal (e.g. one or more BLE Extended Advertising packets).

In embodiments where the central radio device receives and broadcasts data from at least one further peripheral radio device, further transition(s) to further peripheral radio device(s) may similarly occur in response to transition signal(s) in a corresponding way. For instance, a group of peripheral radio devices may each have the ability to request to broadcast to the other peripheral radio devices by sending a transition signal to the central radio device.

In a set of embodiments, the central radio device may simply decide unilaterally to transition from broadcasting data from the first peripheral radio device to broadcasting data from the second peripheral radio device. The central radio device may decide unilaterally to transition to broadcasting its own data (e.g. in response to a user of the central radio device pressing a “push-to-talk” button).

In some sets of embodiments, the central radio device receives data from the first and second peripheral radio devices at the same time (i.e. over two, coexisting unicast connections).

In such embodiments, the central radio device may broadcast a single radio signal in which data received from the first peripheral radio device and data received from the second peripheral radio device are encoded, i.e. such that the central radio device broadcasts simultaneously data from the first and second peripheral radio devices.

In a set of embodiments, broadcasting data from the first and second peripheral radio devices simultaneously involves the radio signal comprising two distinct broadcast streams. For instance, the radio signal broadcast by the central radio device may comprise a first Broadcast Isochronous Stream (BIS) containing data received from the first peripheral radio device and a second BIS containing data received from the second peripheral radio device. In such embodiments peripheral radio device(s) receiving the broadcast may be free to use data in either or both of the streams.

In a set of embodiments, broadcasting data from the first and second peripheral radio devices simultaneously involves encoding a mix of the data from the first and second peripheral radio devices in the (single) radio signal. For instance, audio data from the first and second peripheral radio devices may be mixed at the codec or audio level to produce a single audio stream for broadcast.

Alternatively, in embodiments where the central radio device receives data from the first and second peripheral radio devices at the same time, the central radio device may broadcast the data separately in time (e.g. by delaying data from one peripheral radio device). For instance, the central radio device may apply a predetermined arbitration algorithm to decide a broadcast order for data received from the first and second peripheral radio devices at the same time (e.g. which data to broadcast now and which to delay). At some times, data from a peripheral radio device may simply be discarded rather than being relayed into a broadcast.

As mentioned above, the central radio device may also broadcast its own data to the peripheral radio devices. Features described above in relation to the broadcast of data received from first and second peripheral radio devices may also be applied in an analogous manner to embodiments featuring the broadcast of data from the first and/or second peripheral radio device and data produced by the central radio device.

For instance, in a set of embodiments the central radio device is arranged to broadcast a single radio signal in which data received from the first and/or second peripheral radio device and data produced by the central radio device are encoded (i.e. broadcasting the data simultaneously). Broadcasting data from the first and/or second peripheral radio device and data produced by the central radio device simultaneously may involve encoding a mix of the data in the radio signal. Audio data may be mixed at the codec or audio level to produce a single audio stream for broadcast. The radio signal broadcast by the central radio device may comprise a first Broadcast Isochronous Stream (BIS) containing data received from the first and/or second peripheral radio device and a second BIS containing data produced by the central radio device.

Alternatively, data from the first and/or second peripheral radio device and data produced by the central radio device may be separated into two separate broadcasts (e.g. by delaying data from one radio device). The central radio device may apply a predetermined arbitration algorithm to decide a broadcast order. At some times, data from the first and/or second peripheral radio device or data produced by the central radio device may be discarded rather than being broadcast.

As mentioned above, the unicasts and broadcast may use packet-based communication. In a set of embodiments, the first peripheral radio device transmits data packets to the central radio device over the first unicast radio connection at regular intervals. The data packets may for instance contain sections of a continuous audio stream. In some embodiments, the interval between packets may be long enough to allow one or more retransmissions of a given packet. For instance, the first peripheral radio device may be operable to retransmit a data packet one or more times (e.g. if requested by the central radio device due to an unsuccessful reception of the original data packet). This may aid reliability of the first unicast connection. The second unicast connection may also or alternatively support data packet retransmissions in the same way.

In a set of embodiments, the radio signal(s) broadcast by central radio device include data packets broadcast at regular intervals (e.g. to carry sections of a continuous audio stream). The interval may be the same as a transmission interval for a unicast connection (although the packet intervals may be offset). In some embodiments, the radio signal(s) broadcast by central radio device include one or more retransmissions of each data packet (i.e. in the interval between data packets). This may aid reliability of the broadcast because the peripheral radio devices are unable to request retransmissions themselves (as the broadcast is a one-way one-to-many communication).

In embodiments where one or more unicasts and the broadcast use packet-based communication, a given data packet broadcast by the central radio device may include data from a corresponding data packet received from the relevant peripheral radio device. Accordingly, in a set of embodiments:
the first peripheral radio device transmits a plurality of unicast data packets to the central radio device over the first unicast radio connection with a packet interval between each unicast data packet, and the first peripheral radio device is operable to transmit one or more retransmissions of a given unicast data packet in the packet interval between each unicast data packet;
the central radio device broadcasts a plurality of broadcast data packets with the packet interval between each broadcast data packet, wherein each broadcast data packet comprises data from a corresponding unicast data packet received from the first peripheral radio device; and
the central radio device broadcasts one or more retransmissions of a given unicast data packet in the packet interval between each broadcast data packet.

For maximum reliability, the central radio device may only begin to broadcast a broadcast data packet comprising data from a corresponding unicast data packet after allowing time for all possible retransmissions of said unicast data packet. This may maximise the chances that each unicast data packet is correctly received before it is time to broadcast the corresponding broadcast data packet. However, it has been recognised that a communication latency (i.e. a delay between data being produced at a peripheral radio device (e.g. audio being captured) and that data being received by the other peripheral radio device(s) (e.g. for playback)) may be reduced by adopting a different approach.

In a set of embodiments, the central radio device broadcasts a broadcast data packet comprising data from a corresponding unicast data packet prior to one or more retransmissions of the unicast data packet (i.e. prior to when one or more retransmissions would occur if they were needed). This may reduce communication latency by decreasing the time between the reception and broadcast of data by the central radio device.

The inventors have recognised that this is still likely to result in effective and reliable communication, because even if the central radio device does not receive properly a unicast data packet on the original transmission (and thus can't include said data in the broadcast data packet), it can still include data from the unicast data packet retrieved from a retransmission in the one or more broadcast retransmissions. The peripheral radio devices are thus still likely to receive all of the data, but with the latency associated with the central radio device relay reduced.

The data communicated in the unicast and broadcast radio signals may be any data useful in many-to-many communications. In a set of embodiments the data received over the first and/or second unicast radio connections and/or the data encoded in the radio signal(s) broadcast by the central device are audio data (e.g. captured by the first or second peripheral radio device). One or more of the peripheral radio devices may capture audio for broadcast (e.g. using a microphone and/or an audio interface for capturing audio). As mentioned, the central radio device may broadcast its own data such as audio data and as such the central radio device may capture audio (e.g. using a microphone and/or an audio interface for capturing audio). Captured audio data may be relayed via the unicast and/or broadcast in real-time or near real-time.

One or more of the peripheral radio devices may play back of audio data from the first and/or second peripheral radio device received in the radio signal broadcast by the central radio device (e.g. by decoding the radio signal and processing the audio data into a suitable format). One or more of the peripheral radio device may comprise a loudspeaker and/or an audio interface for playing back audio. The central radio device may also be arranged to play back audio data from the first and/or second peripheral radio device. The central radio device may comprise a loudspeaker and/or an audio interface for playing back audio. Audio data may be played back in real-time or near real-time.

It may be particularly useful to facilitate many-to-many communication of audio data because many human interactions involve oral communication in groups. For instance, the first and/or second peripheral radio devices of the group may broadcast audio data of a person talking (e.g. live audio captured with a microphone), and one or more peripheral radio devices of the group may facilitate playing that audio back through a loudspeaker.

The present invention extends to a radio communication system arranged to perform the method disclosed herein.

The invention also extends to software that, when executed by a radio communication system, causes said radio communication system to perform the method disclosed herein. One or more radio devices of the communication system may comprise a memory storing part or all of said software. One or more radio devices of the communication system may comprise a processor arranged to execute part or all of said software.

According to a second aspect of the present invention there is provided a method of operating a central radio device comprising:
receiving data from a first peripheral radio device over a first unicast radio connection;
broadcasting a radio signal in which data received from the first peripheral radio device are encoded;
receiving data from a second peripheral radio device over a second unicast radio connection; and
broadcasting a radio signal in which data received from the second peripheral radio device are encoded.

According to a third aspect of the present invention there is provided a central radio device arranged to:
receive data from a first peripheral radio device over a first unicast radio connection;
broadcast a radio signal in which data received from the first peripheral radio device are encoded;
receive data from a second peripheral radio device over a second unicast radio connection; and
broadcast a radio signal in which data received from the second peripheral radio device are encoded.

The invention extends to software that, when executed by a central radio device, causes said central radio device to perform the method disclosed herein. The central radio device may comprise a memory storing part or all of said software. The central radio device may comprise a processor arranged to execute said software.

Moreover, features of any aspect or embodiment described herein may, wherever appropriate, be applied to any other aspect or embodiment described herein. Where reference is made to different embodiments, it should be understood that these are not necessarily distinct but may overlap. It will be appreciated that all of the preferred features of the method according to the first aspect described above may also apply to the other aspects of the invention.

### BRIEF DESCRIPTION OF THE DRAWINGS

One or more non-limiting examples will now be described, by way of example only, and with reference to the accompanying figures in which:

FIG. 1 is a schematic diagram showing a radio communication system operated according to an embodiment of the invention at a first time;

FIG. 2 is a schematic diagram showing the radio communication system at a second time;

FIG. 3 is a schematic diagram showing the radio communication system at a third time;

FIG. 4 is a timing diagram illustrating operation of the radio communication system; and

FIG. 5 is a timing diagram illustrating alternative operation of the radio communication system.

### DETAILED DESCRIPTION

A radio communication system 100 comprises a central radio device 102 and three peripheral radio devices 152A, 152B, 152C. The radio devices 102, 152A-152C communicate using Bluetooth Isochronous Channels (ISOC) and specifically according to a Bluetooth LE Audio protocol (although other, non-audio implementations are also possible).

The central radio device 102 comprises a microphone 104, a loudspeaker 106 (e.g. as part of a pair of headphones), a processor 108, a memory 110, a radio front-end portion 112 and an antenna 114. The first peripheral radio device 152A also comprises a microphone 154, a loudspeaker 156 (e.g. as part of a pair of headphones), a processor 158, a memory 160, a radio front-end portion 162 and an antenna 164. Although not illustrated, the second and third peripheral radio devices 152B, 152C also comprise the same components.

The radio communication system 100 provides many-to-many communication between the radio devices 102, 152A-152C. The radio communication system 100 may comprise a conference call system, with each radio device 102, 152A-152C used by a different user to speak and listen to speech from the other users. The central radio device 102 may be used by the host of the conference call. Alternatively, the radio communication system 100 may comprise a workplace communication system, where some of the radio devices 102, 152A-152C are used by employees for communication and at least one of the radio devices 102, 152A-152C is a warning device for issuing audible warnings to employees' devices.

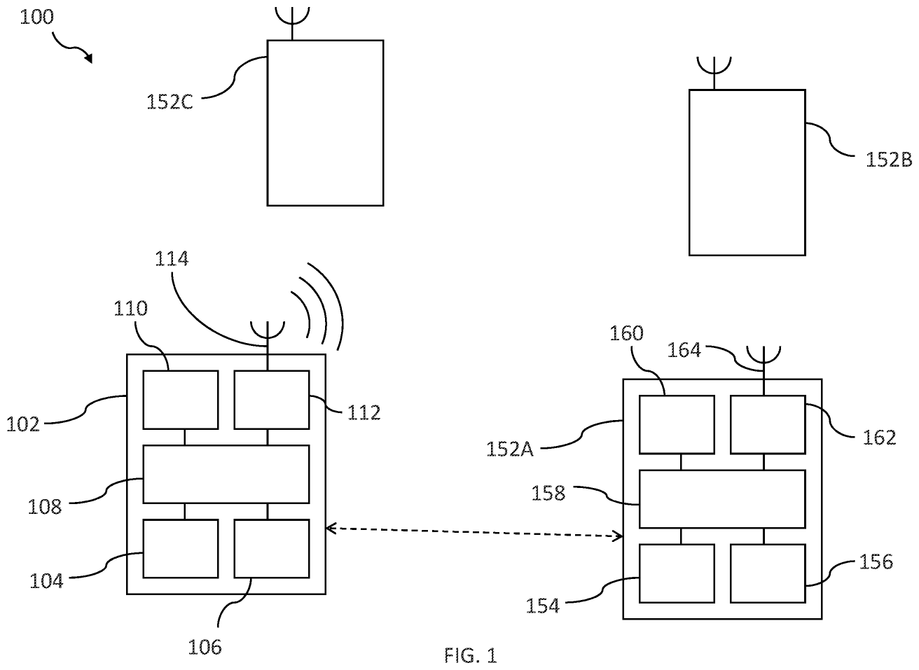

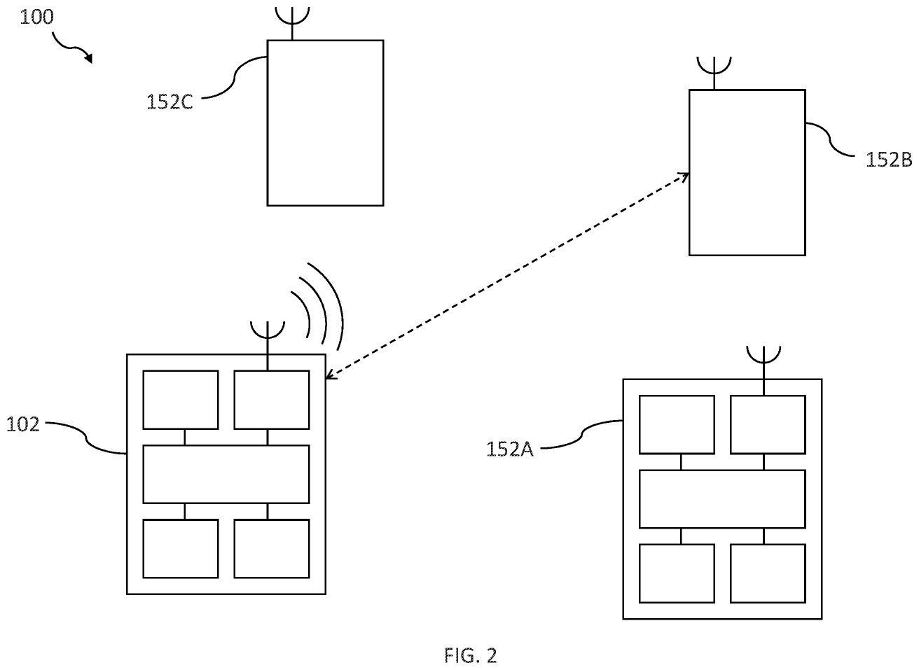

To achieve many-to-many communication, the central radio device 102 forms a unicast connection with each of the peripheral radio devices 152A-152C (although not necessarily at the same time) and relays data received over the unicast connections into a broadcast radio signal, which can then be received by the other peripheral radio devices. This operation will now be described in more detail with reference to FIGS. 1 and 2.

At a first time, illustrated in FIG. 1, the first peripheral radio device 152A and the central radio device 102 are in communication via a first unicast radio connection (indicated by a dashed line). In the first unicast connection, the first peripheral radio device 152A acts as a unicast server, and the central radio device 102 acts as a unicast client. The unicast connection comprises a Connected Isochronous Steam (CIS).

The first peripheral radio device 152A captures audio of a user speaking with its microphone 154, processes the captured sound with the processor 158 to produce a series of data packets in which the sound is encoded, and transmits these data packets using the radio front-end portion 162 and the antenna 164 over the first CIS to the central radio device 102. This process repeats continuously, i.e. to stream audio in real time to the central radio device 102 over the first unicast radio connection.

The central radio device 102 receives the audio data packets from the first peripheral radio device 152A over the first unicast connection (via the antenna 114 and the front-end portion 112). After some processing (e.g. to separate the audio data from header information), the central radio device 102 broadcasts a radio signal using the front-end portion 112 and the antenna 114 in which the audio data from the first peripheral radio device 152A is encoded. The radio signal comprises a Broadcast Isochronous Stream (BIS). The central radio device 102 also plays back the underlying audio from the first peripheral radio device 152B with the loudspeaker 106.

The BIS from the central radio device 102 is receivable by any suitable device in range. The central radio device 102 also broadcasts accompanying periodic advertising packets to advertise the presence and parameters (e.g. broadcast ID, timing) of the BIS. The second and third peripheral radio devices 152B, 152C receive the BIS, decode the data encoded therein and play back the underlying audio with their loudspeakers for their respective users to hear. The central radio device 102 acts as a broadcast source, and the second and third peripheral radio devices 152B, 152C act as broadcast sinks. Audio from the user of the first peripheral radio device 152A is thus communicated in real time to the users of each of the other radio devices in the system 100.

To facilitate many-to-many communication, the central radio device 102 relays audio from each of the peripheral radio devices 152A-152C at a different time. Each of the peripheral radio devices 152A-152C forms a unicast connection with the central radio device 102 and transmits audio data over said unicast connection at a predetermined time according to a predetermined communication schedule, which indicates when and for how long each peripheral radio device 152A-152C will communicate data to the other radio devices 152A-152C.

Thus, at a predetermined transition time set out in the pre-agreed communication schedule, the first unicast connection is disconnected and the first peripheral radio device 152A stops transmitting audio data to the central radio device 102. The second peripheral radio device 152B initiates a second unicast connection comprising a second CIS with the central radio device 102 by transmitting advertisements to which the central radio device 102 responds. FIG. 2 shows the radio communication system 100 at a second time when the second CIS between the central radio device 102 and the central radio device 102 is established. The second peripheral radio device 152B acts as a unicast server, and the central radio device 102 acts as a unicast client.

Once the second CIS with the central radio device 102 is established, the second peripheral radio device 152B captures audio of a second user speaking and transmits corresponding audio data to the central radio device 102 over the unicast connection in the same way as the first peripheral radio device 152A. The central radio device 102 receives the audio data from the second peripheral radio device 152B over the first CIS and broadcasts a radio signal in which the audio data from the first peripheral radio device 152A is encoded. The radio signal is broadcast as a Broadcast Isochronous Stream (BIS), and is simply a continuation of the BIS that carried audio data from the first peripheral radio device 152A. The central radio device 102 also plays back the underlying audio from the second peripheral radio device 152B with the loudspeaker 106.

The third peripheral radio device 152B continues to receive, decode and play back audio data encoded in the BIS from the central radio device 102. However, the audio data being played back is now from the second peripheral radio device 152B. The first peripheral radio device 152A now also begins to receive, decode and play back audio data encoded in the BIS from the central radio device 102.

This process continues in line with the communication schedule, with each peripheral radio device 152A-152C forming a unicast connection with the central radio device 102 and transmitting audio data over this connection at times allotted in the schedule. Throughout operation the central radio device 102 continues to broadcast the BIS with audio data from the current unicast connection encoded therein. The central radio device 102 also captures audio itself using the microphone 104 and broadcast this with the BIS at a time allotted in the communication schedule. In other words, the communication schedule coordinates which data (i.e. data from which device) are encoded in the BIS broadcast by the central radio device 102. The radio communication system 100 thus enables many-to-many communication, with each radio device 102, 152A-152C able to send and receive data to and from each of the other radio devices 102, 152A-152C.

In another embodiment, additionally or alternatively to using a broadcast schedule, the radio communication system 100 uses transition signals to coordinate which data are encoded in the BIS from the central radio device 102. For instance, when the second peripheral radio device 152B wishes to send its audio to all other devices (e.g. just prior to the second time shown in FIG. 2), the second peripheral radio device 152B may issue an advertising packet comprising a transition signal, which indicates to the central radio device 102 that the second peripheral radio device 152B is about to initiate a unicast connection with the central radio device 102. In response, the central radio device 102 may drop the first unicast connection, form a second unicast connection with the second peripheral radio device 152B and begin to relay data from the second peripheral radio device 152B into the BIS. This process repeats as and when each of the peripheral radio device 152A-152C wishes to broadcast its data. Of course when the central radio device 102 wishes to broadcast its own data it may unilaterally do so without needing a transition signal.

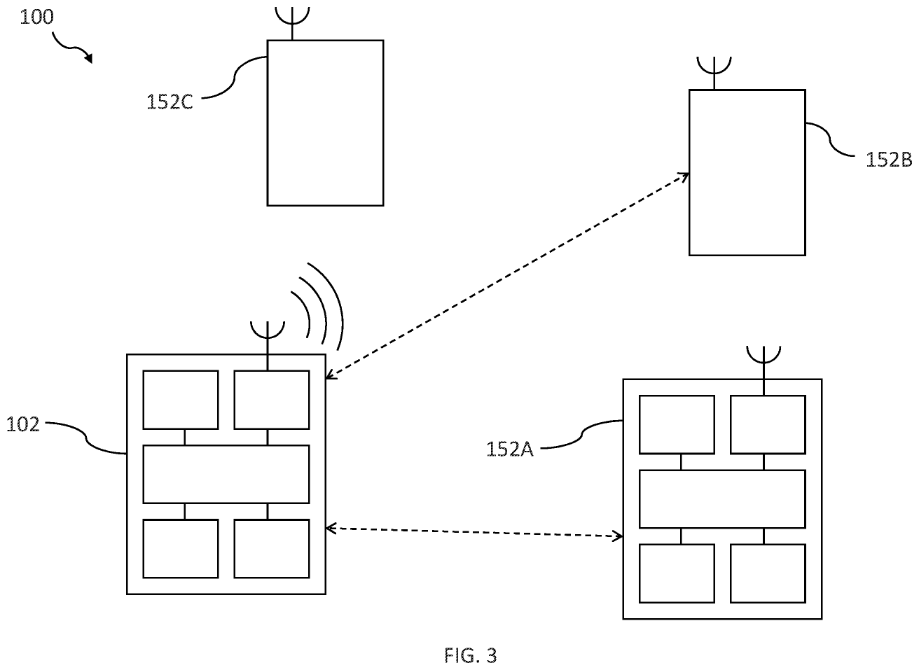

The communication system 100 can also facilitate simultaneous communication of multiple radio devices with multiple other radio devices. This functionality will now be described with reference to FIG. 3, which shows the communication system 100 at a third time.

At the third time, the first peripheral radio device 152A and the central radio device 102 are in communication via a first unicast radio connection comprising a first CIS, and the second peripheral radio device 152B and the central radio device 102 are in communication via a second unicast radio connection comprising a second CIS (both indicated by dashed lines). In each unicast connection, the peripheral radio device 152A, 152B acts as a unicast server, and the central radio device 102 acts as a unicast client.

The central radio device 102 receives audio data simultaneously on both CISs and broadcasts a radio signal in which audio data from the first and second peripheral radio device 152A, 152B is encoded. The audio from the two devices may be mixed together at the audio or codec level to produce a single audio stream that is broadcast in a single BIS, or the audio may be broadcast separately in two parallel Broadcast Isochronous Streams as a Broadcast Isochronous Group (BIG).

The first, second and third peripheral radio devices 152A-152C receive the radio signal broadcast by the central radio device 102 and play back the underlying audio as explained above. When the central radio device 102 broadcasts two BISs in a BIG, each of the peripheral radio devices 152A-152C may decide which of the streams to play back or may mix the audio together locally for joint playback.

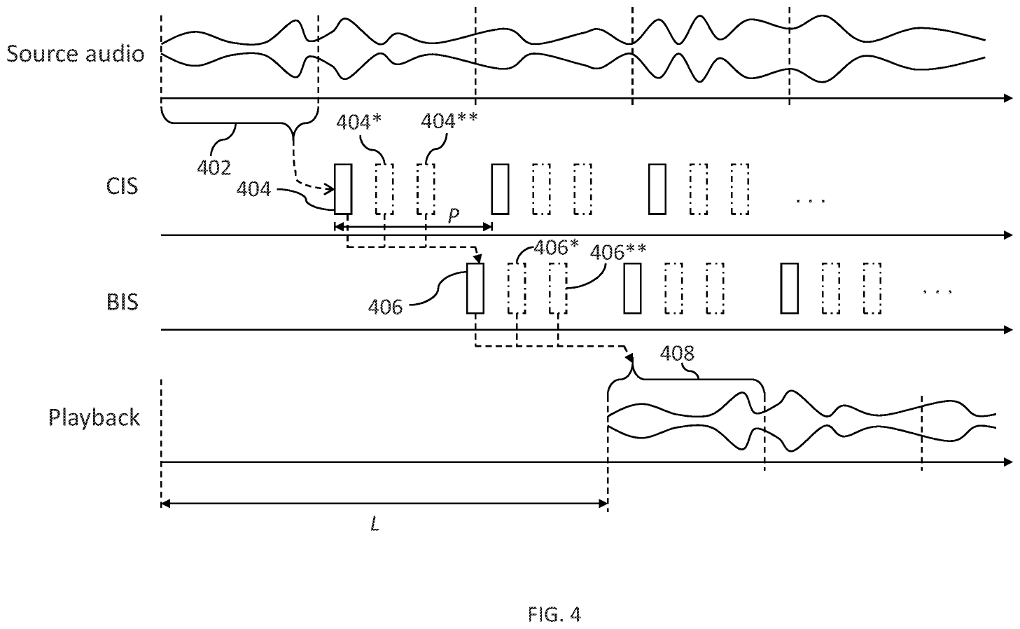

As explained above, the central radio device 102 acts to relay audio data from one or more CISs into one or more BISs, which are received and decoded by the peripheral radio devices 152A-152C before being played back through the loudspeakers. FIG. 4 shows the operation of this process in more detail.

A section of audio 402 is captured by the first peripheral radio device 152A and processed to produce a unicast data packet 404. The unicast data packet 404 is transmitted to the central radio device 102 over the CIS. Subsequent sections of audio are transmitted in subsequent unicast data packets, with a packet interval P between each unicast data packet. To improve reliability, the CIS allocates time in the packet interval P after the transmission of each data packet 404 for two possible re-transmissions 404*, 404**. If the central radio device 102 does not properly receive a unicast data packet 404 (e.g. due to interference) it sends a negative acknowledgement (i.e. a retransmission request) and the first peripheral radio device 152A sends the first retransmission 404* of the unicast data packet 404. If needed, the first peripheral radio device 152A can also send a second retransmission 404**.

The central radio device 102 uses the contents of the unicast data packet 404 to produce a broadcast data packet 406 in which data from the unicast data packet 404 is encoded. After allowing time for all possible retransmissions, the central radio device 102 broadcasts the broadcast data packet 406 over the BIS.

Because the BIS does not support any acknowledgement from receiving devices, the BIS automatically sends first and second retransmissions 406*, 406** of the broadcast data packet 406, to improve the chances of all devices in range properly receiving the packet. Following a short synchronisation and processing delay after the final retransmission 406**, the third and fourth peripheral radio device 152C, 152D play back audio 408 encoded in the broadcast packet 406 corresponding to the section 402. This process repeats for further sections of audio to produce a continuous audio stream with an overall latency L.

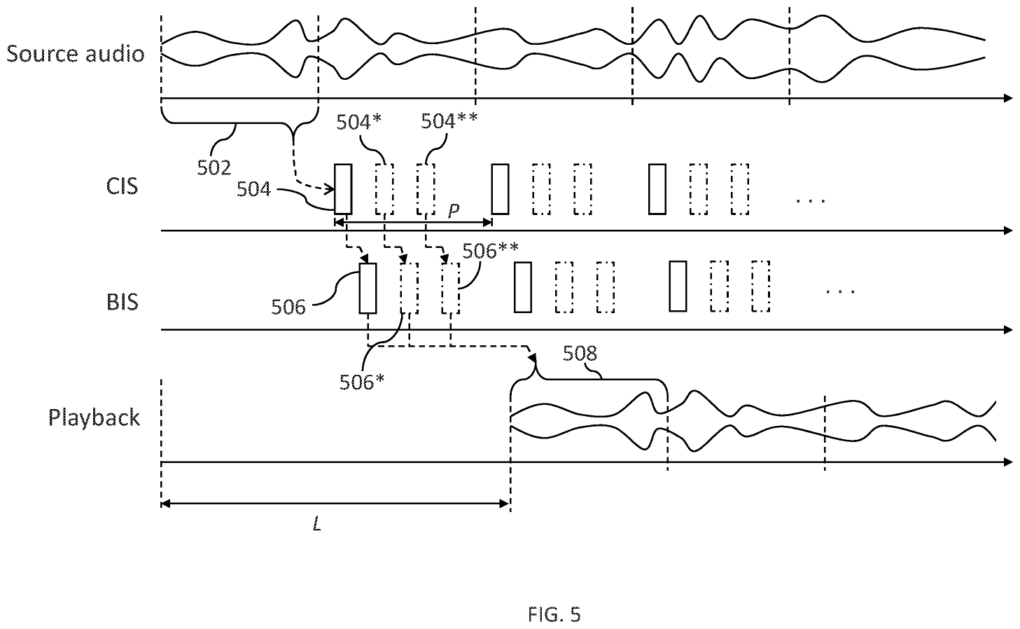

It is desirable to reduce the latency L (i.e. to reduce the delay between a user speaking and their voice being heard by other users). FIG. 5 shows an alternative operation of the radio communication system 100 which experiences reduced latency.

As in the operation illustrated in FIG. 4, a first section of audio 502 is captured by the first peripheral radio device 152A and processed to produce a unicast data packet 504. Subsequent sections of audio are transmitted in subsequent unicast data packets, with a packet interval P between each unicast data packet. Each unicast data packet 504 is transmitted to the central radio device 102 over the CIS and time is allocated in the packet interval P after the transmission of the data packet 504 for two possible re-transmissions 504*, 504**.

However, in this embodiment the central radio device 102 does not allow time for all possible retransmissions before starting to broadcast corresponding BIS packets. The central radio device 102 broadcasts a broadcast data packet 506 after only the original unicast data packet 504 has been transmitted, followed by two re-transmissions 506*, 506**. Following a short synchronisation and processing delay after the final retransmission 506**, the third and fourth peripheral radio device 152C, 152D play back audio 508 encoded in the broadcast packet 506 corresponding to the section 502. This process repeats for further sections of audio to produce a continuous audio stream with a reduced overall latency L.

Of course, if the central radio device 102 does not successfully receive the unicast data packet 504 at the first try, it cannot encode data from the unicast data packet 504 in the broadcast data packet 506. However, if one of the re-transmissions 504*, 504** can be successfully received, this can be used to encode data from the unicast data packet 504 in one or both of the re-transmissions 506*, 506** of the broadcast data packet 506. Communication reliability can thus be maintained with reduced latency L.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of operating a radio communication system comprising a central radio device and a plurality of peripheral radio devices, the method comprising:
the central radio device receiving data from a first peripheral radio device over a first unicast radio connection;
the central radio device broadcasting a radio signal in which data received from the first peripheral radio device are encoded;
at least one peripheral radio device receiving the radio signal broadcast by the central radio device and decoding the data encoded therein;
the central radio device receiving data from a second peripheral radio device over a second unicast radio connection;
the central radio device broadcasting a radio signal in which data received from the second peripheral radio device are encoded; and
at least one peripheral radio device receiving the radio signal broadcast by the central radio device and decoding the data encoded therein.

2. The method of claim 1, comprising the central radio device broadcasting a radio signal in which data produced by the central radio device are encoded.

3. The method of claim 1, comprising:
the central radio device receiving data from at least one further peripheral radio device over at least one further unicast radio connection;
the central radio device broadcasting a radio signal in which data received from the at least one further peripheral radio device are encoded; and
at least one peripheral radio device receiving the radio signal broadcast by the central radio device and decoding the data encoded therein.

4. The method of claim 1, wherein every peripheral device in the system is operable to transmit data to the central radio device for broadcast.

5. The method of claim 1, wherein the radio devices are Bluetooth Low Energy (BLE) devices.

6. The method of claim 1, wherein the first and/or second unicast radio connection comprises a Connected Isochronous Stream and the radio signal(s) broadcast by the central radio device comprises a Broadcast Isochronous Stream.

7. The method of claim 1, comprising the central radio device receiving data from the first and second peripheral radio devices at the same time.

8. The method of claim 1, comprising the central radio device broadcasting at a first time a radio signal in which data received from the first peripheral radio device are encoded and subsequently broadcasting at a second time a radio signal in which data received from the second peripheral radio device are encoded.

9. The method of claim 8, wherein the central radio device transitions from broadcasting data from the first peripheral radio device to broadcasting data from the second peripheral radio device in response to a transition signal.

10. The method of claim 9, wherein the transition signal is issued by the first or second peripheral radio device.

11. The method of claim 1, comprising the central radio device broadcasting a single radio signal in which data received from the first peripheral radio device and data received from the second peripheral radio device are encoded, such that the central radio device broadcasts simultaneously data from the first and second peripheral radio devices.

12. The method of claim 11, wherein the single radio signal comprises a first Broadcast Isochronous Stream containing data received from the first peripheral radio device and a second Broadcast Isochronous Stream containing data received from the second peripheral radio device.

13. The method of claim 11, comprising encoding a mix of the data from the first and second peripheral radio devices in the single radio signal.

14. The method of claim 1, comprising:
the first peripheral radio device transmitting a plurality of unicast data packets to the central radio device over the first unicast radio connection with a packet interval between each unicast data packet, wherein the first peripheral radio device is operable to transmit one or more retransmissions of a given unicast data packet in the packet interval between each unicast data packet;
the central radio device broadcasting a plurality of broadcast data packets with the packet interval between each broadcast data packet, wherein each broadcast data packet comprises data from a corresponding unicast data packet received from the first peripheral radio device; and
the central radio device broadcasting one or more retransmissions of a given unicast data packet in the packet interval between each broadcast data packet.

15. The method of claim 14, comprising the central radio device broadcasting a broadcast data packet comprising data from a corresponding unicast data packet prior to one or more retransmissions of the unicast data packet.

16. The method of claim 1, wherein the data received over the first and/or second unicast radio connections and/or the data encoded in the radio signal(s) broadcast by the central device are audio data.

17. The method of claim 16, comprising one or more of the peripheral radio devices playing back of audio data from the first and/or second peripheral radio device received in the radio signal broadcast by the central radio device.

18. The method of claim 1, comprising, after receiving the data from the first peripheral radio device, breaking the first unicast radio connection and then making the second unicast radio connection.

19. A radio communication system arranged to perform the method of claim 1.

20. A central radio device arranged to:
receive data from a first peripheral radio device over a first unicast radio connection;
broadcast a radio signal in which data received from the first peripheral radio device are encoded;
receive data from a second peripheral radio device over a second unicast radio connection; and
broadcast a radio signal in which data received from the second peripheral radio device are encoded.
